(19) United States
(12) Patent Application Publication
(10) Pub. No.: US 2006/0184839 A1
(43) Pub. Date: Aug. 17, 2006

(54) Erasure determination procedure for fec decoding

(75) Inventors: Alexander Golitschek Edler Von Elbwart, DARMSTADT (DE); Joachim Lohr, Darmstadt (DE)

Correspondence Address: WENDEROTH, LIND & PONACK, L.L.P., 2033 K STREET N. W., SUITE 800, WASHINGTON, DC, 20006-1021, US

(73) Assignee: MATSUSHITA ELECTRIC INDUSTRIAL CO., LTD., OSAKA (JP)

(21) Appl. No.: 10/535,664

(22) PCT Filed: Nov. 25, 2002
(86) PCT No.: PCT/EP02/13234

§ 371 Date: Dec. 30, 2005

(51) Int. Cl. G06F 11/00

(52) U.S. Cl. 714/48

(57) ABSTRACT

A method and a decoder for determining erasures in an FEC (Forward Error Correction) decoding process decoding data encoded with concatenated codes is provided. First output data are generated by decoding first input data Second output data are generated by decoding second input data, the second input data including at least a part of the first output data. The first and the second output data are compared for updating a comparison result accumulation parameter based on the comparison result. Finally, it is determined whether an erasure is to be set based on the updated comparison result accumulation parameter.

The present invention generally relates to the field of communication systems and more particularly to Forward Error Correction schemes which allow or require decoders operating in multiple stages or iterations with passing of information between such stages or iterations.

Forward error correction (FEC) schemes are widely used in communication systems to increase the reliability of information transmission. Some popular FEC codes, which are described in S. Lin, D. J. Costello Jr., Error Control Coding: Fundamentals and Applications, Prentice-Hall 1983 and R. G. Gallager, Low density parity check codes, IRE Trans. Info. Theory, vol. IT-8, pp. 21-28, January 1962, are convolutional codes, turbo codes, Reed-Solomon codes, or low-density parity-check codes.

It is possible to concatenate one or more of such FEC codes to enhance the correction capabilities of the overall coding chain. The following are examples of multistage coding in the transmitter, and consequently required multistage decoding in the receiver.

Serial Concatenation

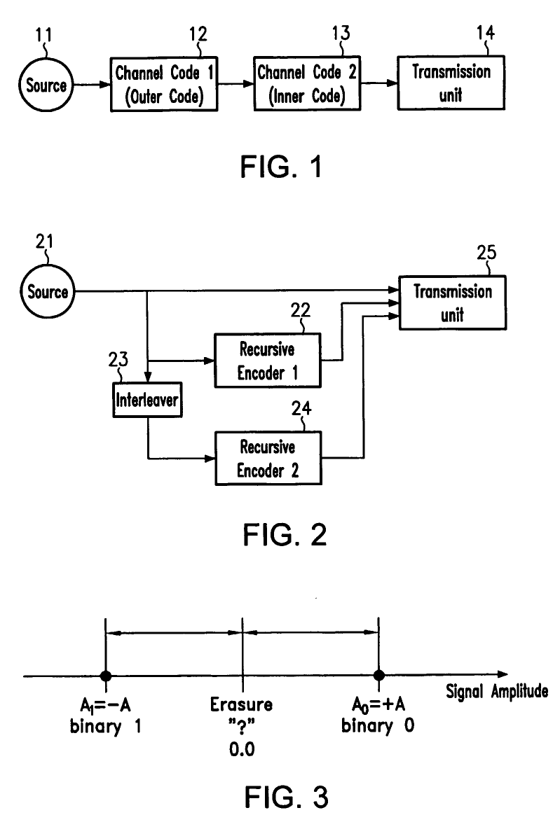

FIG. 1 shows a schematic block diagram for a serial concatenation of FEC codes. Generally, for two concatenated FEC schemes, the first FEC scheme applied to the information is generally referred to as “outer code”, while the second FEC scheme applied to the information is generally referred to as the “inner code”.

In the transmitter illustrated in FIG. 1, a source 41 is connected to a first coding unit 42 providing outer code encoded data as an output. The outer code encoded data from the first coding unit 42 are encoded with an inner code in a second encoding unit 43. Finally, a transmission unit 44 forwards the encoded data towards a corresponding receiver.

Parallel Concatenation

On the other hand, codes can be concatenated in parallel. A widely known example is the Turbo Encoder, of which a schematic block diagram is given in FIG. 2.

Source data from a source 21 are directly transferred to a transmission unit 25. Additionally, the source data are encoded in a first recursive encoder 22 as well as in parallel encoded, after interleaving in an interleaver 23, in a second recursive encoder 22.

Aspects of a Turbo decoding process are discussed in J. Hagenauer, P. Robertson, L. Papke, Iterative (Turbo) decoding of systematic convolutional codes with the MAP and SOVA algorithms, Proc. ITG Tagung, Codierung für Quelle, Kanal und Übertragung, pp. 21-29, October 1994. In the following it will be referred to the terms extrinsic information and soft output in accordance with their definitions in the latter document.

Soft-Input/Soft-Output Decoding

Especially in the turbo decoder, soft-inputsoft-output (SISO) decoders are used for high decoder performance. However, they can be applied to numerous FEC schemes.

Some popular SISO algorithms, are the maximum a posteriori (MAP), SISO Viterbi Algorithm (SOVA), log-MAP, Max-log-MAP, sum-product, and belief-propagation. Examples for such SISO algorithms are provided in A. Burr, Modulation and Coding for Wireless Communications, Prentice Hall, 2001, F. R. Kschischang, B. J. Frey, H.-A. Loeliger, Factor Graphs and the Sum-Product Algorithm, IEEE Transactions on Information Theory, Vol. 47, No. 2, pp. 498-519, February 2001, and R. J. McEliece, D. J. C. MacKay, J.-F. Cheng, Turbo decoding as an instance of Pearl's ‘belief propagation’ algorithm, IEEE J. Select. Areas Commun., vol. 16, pp. 140-152, February 1998.

Erasure Decoding

In case no reliable information has been received for a bit, this unreliable information should be rather disregarded than further evaluated. For this purpose the particular bit can be qualified as an erasure. An information representing such an erasure in a process or indicator has to be accordingly selected. Hence, when qualifying an information as an erasure, the indicator is set to a corresponding value.

A simple example for a definition of input symbols to the decoder is the following:

$${s}_{j} = \{ \begin{matrix}1 & if the jth received value corresponds to a {logical }^{``} {1}^{″} \\ ? & if the jth received value is to be treated as an erasure \\ 0 & if the jth received value corresponds to a {logical }^{``} {0}^{″}\end{matrix}$$

Furthermore, for example in an Additive White Gaussian Noise (AWGN) channel with Binary Phase Shift Keying (BPSK) modulation scenario as illustrated in FIG. 3, an alternative to defining extra erasure symbols is to replace the received unreliable value with a value that carries no information to the decoder if it evaluates the likelihood of a transmitted logical “1” or “0”.

In the scenario of FIG. 3, such a value is the received value of “?”, or for example the value “0.0” provided that the transmission of “1” and “0” is equiprobable and A₀=−A₁.

Different approaches to determine erasures have been discussed. For instance the document C. W. Baum, C. S. Wilkins, Erasure Generation and Interleaving for Meteor-Burst Communications with Fixed-Rate and Variable-Rate Coding, IEEE Trans. Commun., vol. 45, No. 6, pp. 625-628, June 1997, summarises two different schemes referred to as Ratio-Threshold Test (RTT) erasure determination and Bayesian erasure determination.

The RTT erasure determination defines a threshold for the ratio of envelope detection outputs. An erasure is defined, if the ratio exceeds the threshold.

In the Bayesian erasure determination, similar to the RTT erasure determination, there exists an erasure determination threshold. This is determined by utilising decision-theoretic minimisation techniques on a risk function consisting of a linear combination of error and erasure probabilities.

An Output Threshold Test (OTT) erasure determination is proposed in the document L.-L. Yang, L. Hanzo, Low Complexity Erasure Insertion in RS-Coded SFH Spread-Spectrum Communications With Partial-Band Interference and Nakagami-m Fading, IEEE Trans. Commun., vol. 50, no. 6, pp 914-925. The criterion for determining an erasure is the maximum of decision variables input to the maximum likelihood decision unit, i.e. the output of a demodulator.

However, such channel estimation-based erasure determination cannot be readily used for concatenated coding schemes or within multistage or iterative decoding algorithms.

Accordingly, it is the object of the present invention to provide an improved erasure determination method and a corresponding decoder, particularly improved for use in multistage or iterative decoding algorithms.

The object is solved by a method and a decoder device as set forth in the independent claims. Preferred embodiments are described in the dependent claims.

The present invention unveils a method for obtaining measures for erasure candidates for decoding data encoded with concatenated codes. It further gives a criterion for how such measures can be used for determination of erasures and setting of erasure information.

For an FEC decoder which consists generally of multiple stages or iterative decoding with passing of information between stages or iterations, a method is defined by which the erasures are defined. According to an evaluation criterion, such erasures replace received information to improve the overall decoder performance.

In each decoding stage, a metric is obtained that denotes the decoder decision after the respective stage. From stage to stage, it is recorded whether the decoder decision has changed. The cumulative number of changes recorded for each information bit is evaluated to determine whether the respective information is a candidate for erasure in the next decoding stage.

Accordingly, the method for determining erasures in an FEC decoding process for decoding data encoded with concatenated codes initially generates first output data by decoding first input data. Then, second output data are generated by decoding second input data, the second input data including at least a part of the first output data. The first and the second output data are compared for updating a comparison result accumulation parameter based on the comparison result. Finally, it is determined whether an erasure is to be set based on the updated comparison result accumulation parameter.

Such an erasure determination may be implemented by means of components in the decoder or software in a controlling unit thereof. Besides allowing the determination of erasures upon using concatenated coding techniques, the present solution additionally avoids complex and time consuming steps in the determination process.

For a better understanding of the invention, preferred embodiments will be described in the following with reference to the accompanying drawings, illustrating:

FIG. 1 a simple block diagram for serially concatenated codes on the transmitter side,

FIG. 2 a block diagram of a typical turbo encoder to show parallel concatenated codes on the transmitter side,

FIG. 3 a schematic representation of erasure definition in BPSK,

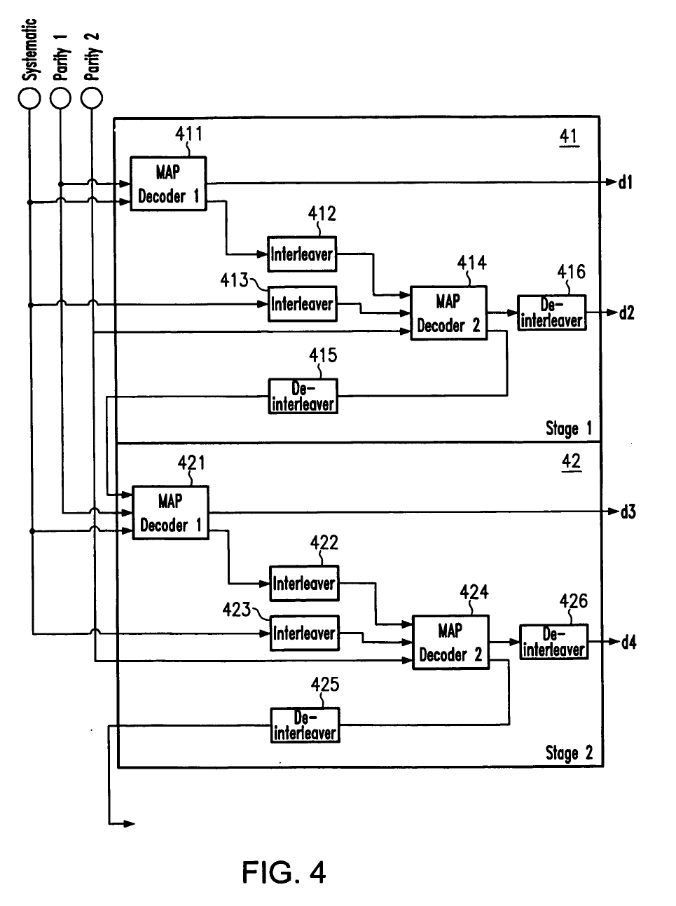

FIG. 4 a block diagram of a commonly used decoder structure for turbo codes, and

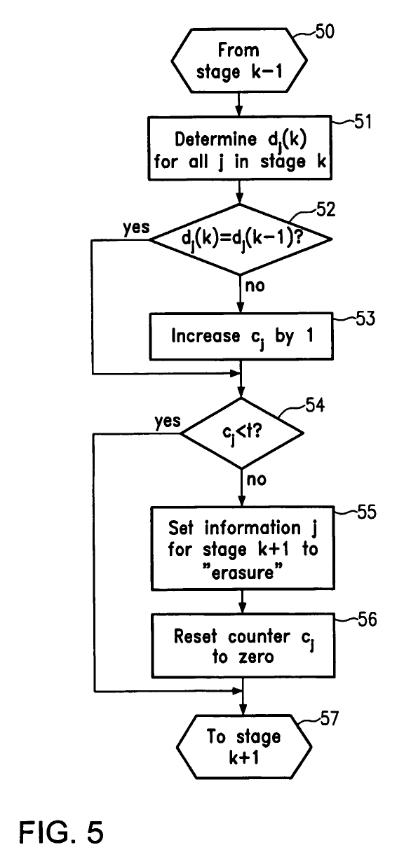

FIG. 5 a flowchart-like representation of the procedure to define an erasure.

In the following, embodiments according to the present invention will be described with reference to FIGS. 4 and 5.

Although the description focuses primarily on multistage decoding techniques with information passed from one stage to another, alternatives to multistage decoding certainly are iterative decoding solutions. As it will become apparent, the present invention can be applied in the same way to iterative decoding schemes as to multistage decoding schemes, provided there exists an iterative decoder solution to the coding problem.

Moreover, it should be noted that the serial and parallel concatenation of codes are not mutually exclusive. In fact it is possible to serially concatenate for example an inner turbo code, which is a parallel concatenation code, with an outer Reed-Solomon code.

Initially, the specific case of a corresponding multistage turbo decoder illustrated in FIG. 4 is described. Subsequently, the more general process illustrated in FIG. 5 is explained, which may be performed in decoders for serial, parallel or combined concatenated coding modes. Finally, turning back to FIG. 4, a more detailed description of corresponding embodiments is provided.

Now referring to FIG. 4, a multistage turbo decoder illustrated therein includes at least two decoder stages 41 and 42. Further optional decoder stages are not illustrated in this figure.

The input data for the multistage turbo decoder are systematic data, which may correspond to the original source data within the encoder, as well as first and second parity data, independently derived in separate coding steps within the encoder.

A first decoding unit 411 of the first decoding stage 41 receives the systematic data and the first parity data for MAP decoding same. The output data of the first decoding unit comprise decision data d1 provided as an output of the decoder and extrinsic information a1 input to a first interleaver 412 of the first decoding stage.

A second decoding unit 414 of the first decoding stage 41 receives the systematic data, interleaved in a second interleaver 413, the second parity data and the interleaved extrinsic information for MAP decoding same. The output data of the second decoding unit 412 comprise decision data and extrinsic data. The decision data are input to a first de-interleaver 416 and provided as an output d2 of the decoder. The extrinsic information are input to a second de-interleaver 415 of the first decoding stage for providing the de-interleaved extrinsic information a2 as an input for the second decoding stage 42.

A detailed description of the second decoding stage 42 can be omitted, since it may be arranged as the first decoding stage 41, besides using the output of the previous decoding stage 41 as an additional input. The output provided by the second decoder stage 42 are decision data d3 and d4 as well as de-interleaved extrinsic information a4 for use in a subsequent non-illustrated decoding stage.

Hence, the multistage turbo decoder decodes input data encoded with parallel concatenated codes by iteratively performing decoding steps. In this case two steps of decoding are performed in each decoding stage. However, in the sense of the present invention FIG. 4 may as well be considered to comprise four decoding stages.

The basic concept of the present invention is now explained with reference to FIG. 5.

The process of determining erasures as illustrated in steps 50 to 57 of FIG. 5 are performed for each stage k of a decoding process.

A decision dⱼ(k) is generated or determined in step 51 for all symbols j at the decoding stage k. The generated decision dⱼ(k) is then compared with the corresponding decision dⱼ(k−1) of the previous decoding stage k−1 in step 52.

A counter cⱼ is defined for every symbol j of a single infoword. This counter is increased in step 53 in accordance with the comparison result. Hence, the value of the counter is updated each time the decoder decision changes its value compared to the decision of the previous stage. The counter cⱼ is to be incremented by Δⱼ according to the following rule (1):

$${Δ}_{j} = \{ \begin{matrix}+ 1 & if {d}_{j} ( k ) \neq {d}_{j} ( k - 1 ) \\ 0 & else\end{matrix} \qquad ( 1 )$$

This is applicable only after at least two stages or steps of decoding. After the counter cⱼ are updated for stage k, they may be compared in step 54 to a previously defined comparison result threshold t. If this threshold is exceeded, the information corresponding to symbol dⱼ(k) which is passed to the next decoding stage is set to erasure in step 55, according to what has been defined above. Such an erasure determination will be referred to as a decision-threshold test (DTT).

Finally, before proceeding to the next decoding stage k+1, the counter cⱼ may be reset to zero in step 56. Alternatively, it may be suitable to reset the counter cⱼ to a predefined value in order to indirectly reduce the threshold for a second erasure of the information.

Hence, in the process generated output data of a first and a second decoding step are compared to each other. The comparison result is accumulated by updating a corresponding parameter or counter, which allows to determine whether an erasure is to be set. The erasure is preferably set in the input data for a subsequent step of generating decoded output data.

Since the required comparison result is limited to the information whether the decoded output has changed, the step of comparing may be performed by evaluating whether the respective two symbols (or bits) in the corresponding outputs are equal.

The above process can be applied either after each decoding stage, or alternatively after one or more given numbers of decoding stages have been executed. In the latter case a preferred embodiment is to apply the above method after all decoding stages have been processed.

In such FEC decoding processes a sequence of decoder stages may be used, each subsequent decoder stage receiving at least a part of the output data of a previous decoder stage.

In a further improved embodiment, the DTT counter cⱼ is not evaluated before a number of stages kₘᵢₙ have been processed. This means that cⱼ is zero until after stage kₘᵢₙ has been processed. Therefore, the first determination of Δⱼ starts with k=kₘᵢₙ+1 in rule (1). Likewise the first time that all steps in FIG. 5 are executed is for k=kₘᵢₙ+1.

Additionally, in view of the above, it should be noted that the step 51, the steps 52 and 53 as well as the steps 54 to 56 may be regarded as three independent parts, which may be executed when appropriate only. Different ways to use these parts will be described in more detail below when referring again to FIG. 4.

However, performance studies have shown that DTT alone is not the optimum criterion for erasures.

A combination of DTT with a RTT-based criterion is therefore preferably used. In this embodiment a second criterion apart from DTT has to be fulfilled. The second criterion is based upon the soft output value aⱼ(k), i.e. the information obtained for symbol j after stage k. Preferably this is a soft metric on the reliability of decision dⱼ(k), as for example the absolute value of a log-likelihood ratio. Then, the cⱼ has to exceed the threshold t_{c} and simultaneously the aⱼ has to fall below a certain threshold tₐ, if an erasure is to be declared.

Consequently, for such an embodiment, the erasure determination part in FIG. 5 would have to be supplemented with corresponding steps between the steps of comparing the counter 54 and setting the erasure 55.

It should be noted that proper thresholds depend mainly on the system design. However, particularly thresholds tₐ can be analytically derived from the probability of error in the decision by those skilled in the art. For threshold t_{c} we have found good performance results for t_{c}>k/2. Particularly when testing at least one of the criterions after each decoding step or decoding stage, the comparison result threshold t_{c} may depend on the number of previously performed output data comparisons.

In the above mentioned DTT method it is checked if the counter cⱼ exceeds a predefined threshold. Alternatively it is also possible to check cⱼ for specific values according to the error statistic after decoding. Hence, an error statistic is calculated after the final decoding stage for determining a specific threshold value based on the error statistic result. Then in a step of erasure determining, which is performed after the final decoding stage, the specific threshold is used as a decision criterion.

Some studies were made using a turbo code as an inner code and a Reed-Solomon code as an outer code. The total number of inner decoding stages was chosen as 8 . Considering the error statistic after 8 decoding stages in the DTT, all information bits with the counter cⱼ equal to 1 or greater than 2 were defined as fulfilling the DTT criterion, which was combined with the results from the RTT criterion to determine erasures. The counter cⱼ was evaluated after the second decoding stage, i.e. kmin=2.

Reed-Solomon code symbols generally consist of n bits, n being an integer value of 1 or greater. Since Turbo decoders typically define bit erasures, a Reed-Solomon symbol received in the Reed Solomon decoding portion may be defined as an erasure if one or a predefined number the n bits within that Reed-Solomon symbol are set to be erasures.

Another aspect of the invention thus becomes apparent in the following. The steps of comparing the output data and updating the comparison result value, for example depending on the decoding algorithm, may be performed on a bit or symbol basis. Moreover, the erasures may be correspondingly defined for associated bits or symbols. However, similar to the above case of converting Turbo Code erasures to Reed Solomon erasures, a bit based comparison result may trigger a symbol erasure or vice versa.

Those skilled in the art of turbo decoding will perceive that there exist different variations as to the passed information between decoders. For the present invention this imposes no problem, since for any decoder it is inherently clear which information is passed on to the next stage, and which information contains the decoder decision. Generally they are different, but in certain implementations they can be identical.

A Log-likelihood ratio (LLR) is defined as the logarithm of the ratio of probabilities. In this context it is clear that a ratio of 1 carries no useful information, as it signifies that two events are equiprobable. Therefore a ratio of 1, i.e. a LLR of 0 carries no information, which is equivalent to the meaning of erasure. Hence, in particular an erasure may be set by changing an LLR to 0.

Generally, the information that a data item is regarded as an erasure may be stored either separate from the data item, in an additional state information or an existing information, such as an LLR, associated to the data item, but even in the data item itself, if the data item can carry a value corresponding to an erasure.

Now turning back to the specific case of Turbo Decoding and the decoder illustrated in FIG. 4, further embodiments will be described. It should be noted that the corresponding features and advantages are nevertheless as well applicable to decoders for serial or combined mode concatenated coding.

A turbo code consists usually of two or more parallel concatenated codes. In the decoder, typically so-called extrinsic information on the information bits is passed between the decoder stages. Generally, the extrinsic information that is passed between decoders is not equivalent to the decision of the decoder.

Therefore, the present decision criterion preferably refers to the decision variables, also known as soft-output, of the decoder. Referring the criterion to the extrinsic information is generally suboptimal.

The type of information that is set to erasure, however, should preferably be the systematic information input to subsequent decoder stages and/or the information that is passed between decoder stages, also referred to as extrinsic information.

In accordance with the process illustrated in FIG. 5, the decision data d1 to d4 will be compared to each other in order to detect changes. In particular, the comparison may be performed between decision data of different or the same decoding stage. Hence, d1 and d2, (optionally d2 and d3) as well as d3 and d4 may be compared. Furthermore, d1 and d3 as well as d2 and d4 may be compared to each other. Further combinations are apparently possible.

As already indicated above, such approaches using different comparison configurations are not restricted to using the process illustrated in FIG. 5, which is performed after each stage. To the contrary, the three independent parts may be performed selectively. For example, the step of comparing 52 decoding outputs may be performed after each step of decoding 51, i.e. immediately when d1 or d3 are generated, to avoid the need for storing output data which will not be further processed.

The comparison results will be used to update a comparison result accumulation value or counter, which is subsequently compared to a predefined corresponding threshold. The output of the decoding unit, preferably the extrinsic information, is then set to erasure, if the threshold is exceeded.

The decoder illustrated in FIG. 4 may be supplemented with either dedicated circuits or a control unit for performing the above steps in accordance with the invention.

However, a decoder according to the present invention may as well be implemented by means of a DSP, which performs the decoding in an iterative manner. In this regard the DSP may use a single decoding unit in an iterative manner. Accordingly, the DSP may perform the corresponding steps as a control unit.

Apart from the above embodiments, other information than extrinsic information may be set to erasure. This can comprise the systematic bits as well as parity bits that have a relation to the information symbol j. Such relations can be derived for the respective coding schemes, for example in a convolutional encoder the memory length plays a vital role.

1. A method for determining erasures in an FEC (Forward Error Correction) decoding process decoding data encoded with concatenated codes, the method comprising the steps of:
generating first output data by decoding first input data;
generating (51) second output data by decoding second input data, the second input data including at least a part of the first output data;
comparing (52) the first and the second output data;
updating (53) a comparison result accumulation parameter based on the comparison result; and
determining (54), based on the updated comparison result accumulation parameter, whether an erasure is to be set.

2. The method according to claim 1, wherein the first and second output data are generated in different or the same decoder stages.

3. The method according to claim 1, wherein the erasure is set in the input data for a subsequent step of generating decoded output data.

4. The method according to claim 1, wherein the FEC decoding process uses a sequence of decoder stages, each subsequent decoder stage receives at least a part of the output data of a previous decoder stage.

5. The method according to claim 1, wherein the FEC decoding process is performed in an iterative manner.

6. The method according to claim 1, wherein the step of comparing is performed by evaluating whether respective symbols in the first and the second output are equal.

7. The method according to claim 1, wherein the step of comparing is performed at least for two different pairs of output data, and wherein the comparison result accumulation parameter stores the comparison results for corresponding previous comparisons.

8. The method according to claim 1, wherein the step of comparing is performed between first and second decision data each included in the respective output data.

9. The method according to claim 1, wherein the first and second output data each comprise extrinsic data, the extrinsic data in the first output data being the part used as the input for generating the second output data.

10. The method according to claim 1, wherein the erasure is set in a part of the second output data, which is used as an input for a subsequent step of generating decoded output data.

11. The method according to claim 1, wherein at least the step of comparing is performed per bit or symbol of the output data.

12. The method according to claim 1, further comprising: generating third output data by decoding third input data, the third input data including at least a part of the second output data, comparing the third and the second output data, further updating the comparison result accumulation parameter based on the comparison result between the third and the second output data, and determining, based on the further updated comparison result accumulation parameter, whether an erasure is to be set.

13. The method according to claim 1, wherein the step of updating the comparison result accumulation parameter is performed by modifying a counter when the comparison result indicates that the compared output data are unequal, and wherein the step of determining includes comparing the comparison result accumulation value with a predefined comparison result threshold that depends on the number of respective output data comparison steps performed.

14. The method according to claim 5, wherein the steps of comparing and determining are performed after each decoding stage, or after each decoding stage subsequent to a minimum number of decoding stages, or after a predetermined number of decoding stages.

15. The method according to claim 5, further comprising performing an error statistic after the final decoding stage, determining a specific threshold value based on the error statistic result, and in the step of determining, which is performed after the final decoding stage, using the specific threshold as a decision criterion.

16. The method according to claim 1, wherein the decoding process decodes data encoded with a Turbo Code as an inner code and a Reed Solomon Code as an outer code.

17. The method according to claim 1, wherein the erasure is a log-likelihood ratio having the value zero.

18. The method according to claim 5, wherein the step of determining defines erasures for systematic data or parity data input to a subsequent decoding stage.

19. The method according to claim 1, wherein the step of determining further includes a step of checking whether a soft metric of the output data is smaller than a soft metric threshold.

20. The method according to claim 19, wherein the soft metric threshold is determined based on a decision error probability.

21. An FEC (Forward Error Correction) decoder device for decoding data FEC encoded with concatenated codes, the FEC decoder comprising:
decoding means arranged for generating first output data by decoding first input data and generating second output data by decoding second input data, the second input data including at least a part of the first output data; and
an erasure decision unit arranged for evaluating whether the first and the second output data are equal, for updating a result accumulation parameter based on the evaluation result and a previous value of the result accumulation parameter, and for determining, based on the comparison result accumulation parameter, whether an erasure is to be set.

22. An FEC (Forward Error Correction) decoder device for decoding data FEC encoded with concatenated codes the FEC decoder comprising:
decoding means arranged for generating first output data by decoding first input data and generating second output data by decoding second input data, the second input data including at least a part of the first output data, and
an erasure decision unit arranged for evaluating whether the first and the second output data are equal for updating a result accumulation parameter based on the evaluation result and a previous value of the result accumulation parameter, and for determining based on the comparison result accumulation parameter whether an erasure is to be set:
wherein said FEC decoder is adapted to operate in accordance with a method of claim 1.

23. The FEC decoder device according to claim 21, wherein the decoding means includes a multistage turbo decoder.

24. A receiver for use in a communication system, the receiver comprising the FEC decoder device according to claim 21.

25. A communication device comprising the FEC decoder device according to claim 21.
